(19) United States
(12) Patent Application Publication
(10) Pub. No.: US 2006/0118992 A1
(43) Pub. Date: Jun. 8, 2006

(54) Process of maniudacturing dual-layered thermal insulation composite panel

(76) Inventors: Geng-Wen Chang, Taipei City (TW); Mau-Yi Huang, Banciao City (TW); Guang-Shyang Ger, Banciao City (TW); John-Chang Chen, Taipei City (TW)

Correspondence Address: RABIN & BERDO, P.C.;Suite 500, 1101 14 Street, N.W., Washington, DC, 20005, US

(21) Appl. No.: 11/002,147

(22) Filed: Dec. 3, 2004

(51) Int. Cl. B29C 70/44

(52) U.S. Cl. 264/138; 264/258

(57) ABSTRACT

A dual-layered thermal insulation composite panel includes an out layer of high-temperature resistant carbon fiber reinforced phenolic resin composite and an inner layer of low thermal conductivity and high-purity silica fiber reinforced phenolic resin composite. A hot press or autoclave may be used to pressurize said materials into shaping. The dual-layered thermal insulation composite panel achieves excellent performance in thermal resistance, thermal insulation and mechanical strength.

### BACKGROUND OF THE INVENTION

1. Field of Invention

The present invention relates to a process of manufacturing dual-layered thermal insulation composite panel.

2. Related Art

Thermal insulation panels are well used in metal molds, thermal press and injection molding machines for thermal insulation from electrical or steam heat source. They are also applied in defense technology such as missile heat shields, rocket propulsion and launching system for thermal insulation at high temperature. Asbestos has been the most popular thermal insulation material among others, due to its naturally unfailing supply, good process ability and insulation effect. However, it has been proved that asbestos are carcinogenic and thus production, transport, storage and demolish of asbestos are under strictly international control. Therefore, a substitute material for asbestos has been eagerly developed.

U.S. Pat. No. 5,683,799 discloses a thermal insulation panel which is a composite structure of hollow glass fiber and polymeric matrix such as polyester and epoxy resin. A polymeric foam is used as an interlayer in the composite structure. The hollow glass fiber and the foam provide low thermal conduction. U.S. Pat. No. 4,858,635 uses polystyrene foams, polyethylene and polypropylene films to form a thermal insulation panel, in which the low thermal conductivity is achieved through foam interlayer. Daewoo Heavy Industries, Ltd. Korea (MD-Vol 56 Recent Advances in Composites material, ASME 1995) discloses a large thermal insulation component in a form of sandwich structure. The top surface of this thermal insulation structure is using carbon fiber/phenolic composites with an inner layer of polyurethane (PU) foam. Glass fiber/phenolic composite is used as an underneath layer of the thermal insulation structure. This large thermal insulation structure is used as an ablative shield of the rocket launching system.

The prior art described above discloses the three-layered structure with a foam interlayer. Although the interlayers of polyethylene and PU foam can reduce thermal conductance, they can only maintain approximately 100-150° C. Furthermore, these three-layered structures have not enough high temperature mechanical strength so that constructional layers cannot be molded at once.

### SUMMARY OF THE INVENTION

It is therefore an object of the invention to provide a process of manufacturing a dual-layered thermal insulation composite panel satisfying requirements of high temperature resistance, high thermal insulation capability, high mechanical strength, and can be molded at once.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustrations only, and thus are not limited, and wherein:

FIG. 1 illustrates the thermogravimetric weight analysis (TGA) curve and its primary differential curve obtained from the TGA of the phenolic resin that is formed by using the ammonia as the catalyst, wherein the analysis is conducted in the air at temperature increasing rate of 20° C./min;

FIG. 2 shows the packing sequences of prepregs for the dual-layered thermal insulation composite panel using the autoclave;

FIG. 3 is the temperature-pressure curve for manufacturing the dual-layered thermal insulation composite panel using the autoclave;

FIG. 4 is a flow chart showing the dual-layered thermal insulation composite panel manufacture process; and

FIG. 5 is the temperature curve measured on a back of the panel, wherein the panel is subjected to flame jet of solid rocket motor at temperature of 2700° C. and at a distance of 15 cm away from the panel.

### DETAILED DESCRIPTION OF THE INVENTION

Dual-layered thermal insulation composite panel includes an outer layer close to a heat source and configured to tolerate high temperature, and an inner layer encountering less thermal impact. The dual-layered thermal insulation composite panel can be applied in missile heat shields, rocket propulsion systems to stand a high intensity heat in short time. When the missile motor is operating, the temperature of nozzle flame can reach 2000-3000° C. in a very short time. Therefore, the panel must resist, in addition to high temperature, great thermal stress due the high temperature gradient. Therefore, the invention provides a process of manufacturing a dual-layered thermal insulation composite panel. In the invention, the outer layer is made of, for example, high-temperature resistant and high strength polyacrylnitrile (PAN) carbon fiber reinforced phenolic resin composite. The inner layer is made of low thermal conductance and high-purity silica fiber reinforced phenolic resin composite. These composites may be molded by hot press or autoclave.

The PAN-based carbon fiber used in the dual-layered thermal insulation composite panel can tolerate up to 2500° C. and has high mechanical strength. Silica fiber of purity of more than 98% can stand up to 1500° C. and has low thermal conductance. The specifications of those two fibers are listed in Table below.

TABLE 1

| | Unit weight | Woven | Warp counts | Weft counts |
|---|---|---|---|---|
| Material | Oz/Yd2 | type | per inch | per inch |
| 3K | 10.7 | 8HS | More than 24 | More than 24 |
| PAN-based | | | | |
| carbon fiber | | | | |
| Silicon | 18.5 | 8HS | More than 50 | More than 40 |
| dioxide fiber | | | | |

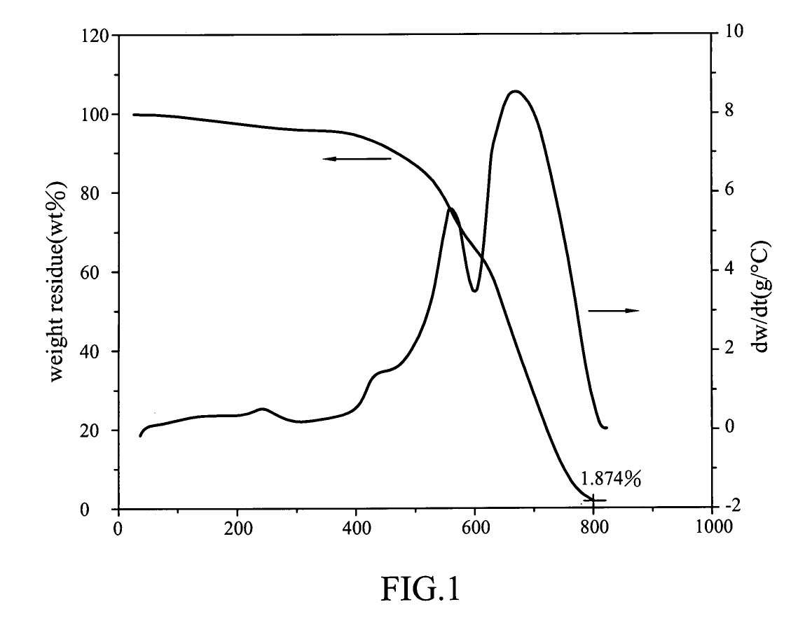

The phenolic resin of the thermal insulation composite panel is made by condensation polymerization using ammonia, formaldehyde and phenols. No alkaline metal compounds such as sodium hydroxide and barium hydroxide is contained in the reaction to avoid alkaline ions that catalyze the decomposition of the phenolic resin at high temperature. Using the phenolic resin as the matrix material to make the dual-layered thermal insulation composite panel increases the thermal resistance of the panel as shown in FIG. 1. The thermal resistance can be evaluated by thermogravimetric weight analysis in air at temperature increasing rate of 20° C./min.

The duel-layered thermal insulation composite panel has the following advantages as below:

1. Taking the thermal flux and temperature impact in use into consideration, the outer layer close to the heat source is made of high cost carbon fiber composite, while the inner layer is made of less expensive high-purity silica fiber composite. Therefore, the production cost is reduced.

2. When being heating, the panel encounters a great temperature gradient. The carbon fiber outer layer has a thermal expansion coefficient lower than the silica fiber inner layer, effectively reducing the thermal stress inside the layers.

3. The high-strength carbon fiber outer layer stands high temperature, and the silica inner layer has low thermal conductivity. The combination of these different materials of different thickness provides various thermal resistance, thermal insulation and mechical strength.

4. The outer and inner layers are laminated and then molded in the autocalve or by hot press to obtain the panel.

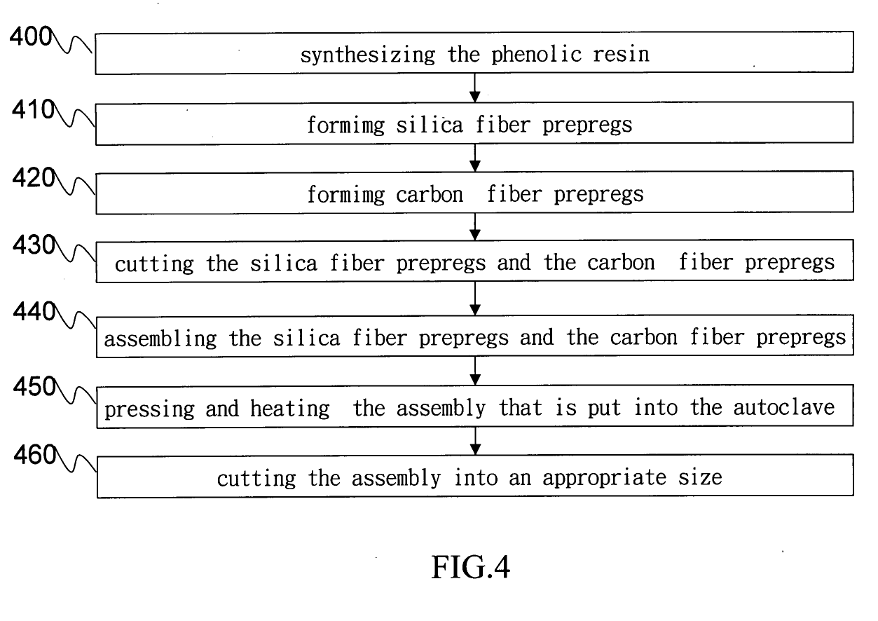

The process according to the invention can provide dual-layered thermal insulation composite panel of different thermal resistance, thermal insulation and strength as desired. The flow chart of manufacturing the dual-layered composite using the autoclave is shown in FIG. 4.

The production of the inner layer is described below. Formaldehyde (purity 36-38%) and phenol (purity 90-95%) at molar ratio of 1.2-1.3:1 are reacted with each other at 100±2° C. for 50-60 minutes, using 35-37% ammonia as a catalyst. The phenolic resin is diluted with isopropanol to obtain 60±3% of phenolic resin solution (step 400) . Using a prepreg machine, the phenolic resin solution is applied over the silica fiber (more than 98% silicon dioxide content) at impreganted temperature 120±5° C. to obtain a prepreg 1 (step 410). The obtained prepreg 1 contains 35±3% of phenolic resin (measured by burning weighting method), 92±2% of dissolvable resin (measured by acetone extraction), and 3-5% of volatiles. The silica fiber weave pattern in prepreg 1 is 8 harness satins (8HS). Such a silica fiber has low thermal conductance.

The production of the outer layer is similar to that of the inner layer. At the impreganted temperature 120±5° C., the phenolic resin solution is applied over the carbon fiber fabrics to obtain a prepreg 2 (step 420). The prepreg 2 contains 38±4% of phenolic resin, 93±2% of dissolvable resin, and 4-6% of volatiles. The prepreg 2 is 3K PAN-based carbon fiber and is woven in the 8-harness satins (8HS) pattern. Such a carbon fiber has balanced properties of thermal resistance and mechanical strength.

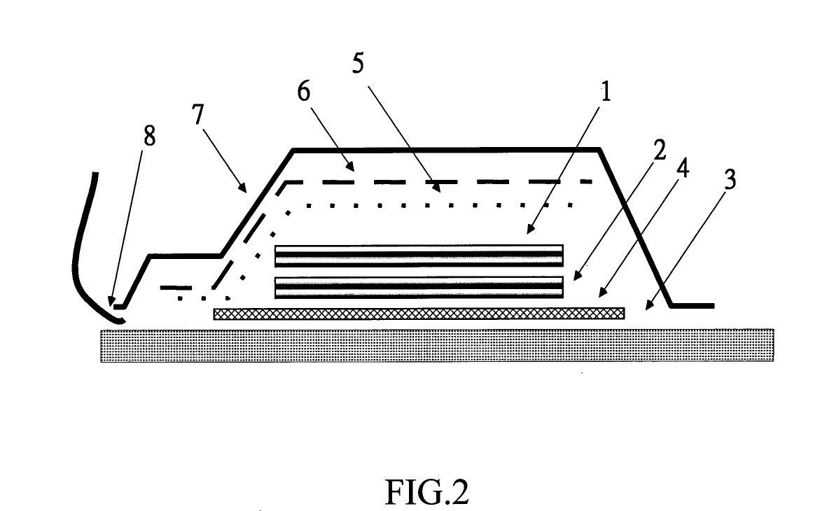

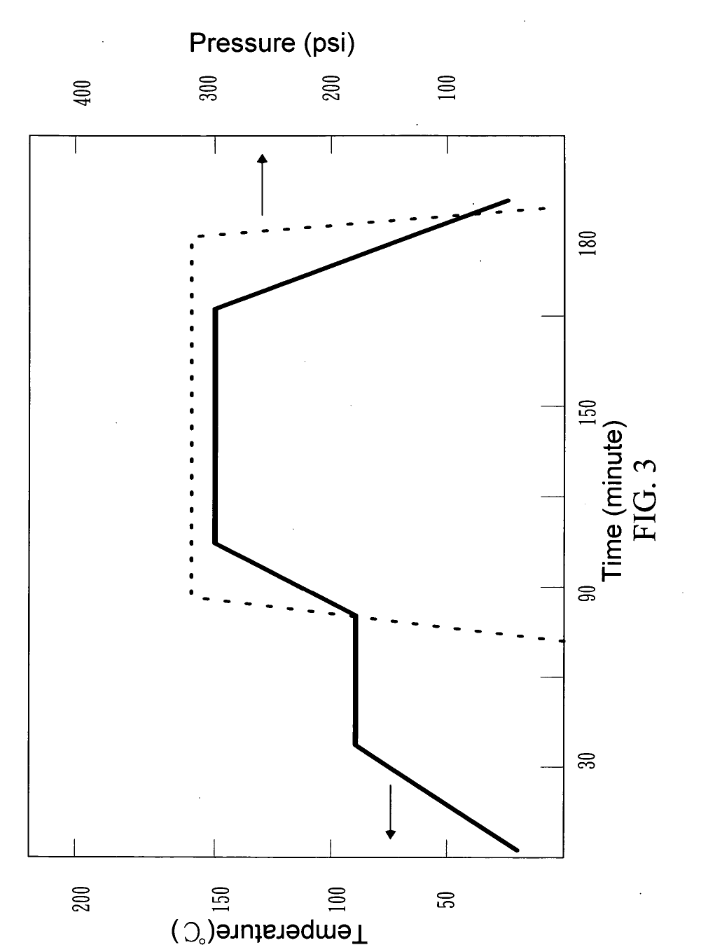

The prepreg 1 and prepreg 2 are cut into a predetermined amount and then laminated over the upper surface of an aluminum alloy template 3 as shown in FIG. 2 (step 430). The aluminum template 3 has release film 4 thereon. A porous release film 5 having the same size as the prepregs 1 and 2 is attached on the laminate. A polyester bleeder 6 is placed on the porous release film 5. A silicone elastomer 7 and a vacuum valve 8 are assembled therewith (step 440). The assembly is put into the autoclave and subjected to de-gas, pressing, and heating according to the relationship between pressure, temperature and processing time as shown in FIG. 3 (step 450). Thereafter, the release film 4, the porous release film 5 and the polyester bleeder 6 are removed to obtain the thermal insulation panel. The obtained panel is cut into an appropriate size (step 460).

In the case that the panel is obtained by hot press, the mold needs to coat with chromium, polish and then apply with release wax. The prepregs 1, and 2 are cut into a predetermined amount and laminated on the mold. After prepregs 1 and 2 are molded in the hot press, a panel is obtained, which can be cut into an appropriate size.

### EXAMPLE 1

The outer layer includes 2 layers of carbon fiber reinforced phenolic resin composite, and the inner layer includes 10 layers of high-purity silica fiber reinforced phenolic resin composite. The autoclave is used in this example.

The 2 layers of carbon fiber reinforced phenolic resin prepregs, and the 10 layers of high-purity silica fiber reinforced phenolic resin prepregs are laminated on an aluminum alloy plate of 3 mm thickness that has an Airtech release film thereon already. A porous release film (Airtech A5000) having the same size of the laminate is applied over the laminate. Then, a polyester bleeder (Airweave SS-FR) is applied over the porous release film. The silicone sleeve (GE V240) and the vacuum valve are assembled therewith. The assembly is put into an autoclave. Then, a vacuum hose from the autoclave is connected to the vacuum valve. After the door of the autoclave is closed, vacuuming and heating with pressure are conducted. The assembly is molded in three stages. The first stage is conducted by heating for 1 hour and 50 minutes at molding pressure of 300 psi and temperature of 85° C. At the second stage, the temperature is firstly increased to 150° C. at a rate of 1.3° C./min, then kept at 150° C. for 4 hours. The last stage is cooling. Thereafter, the release film and the polyester bleeder are removed to obtain the panel. The panel can be machined into an appropriate size and shape.

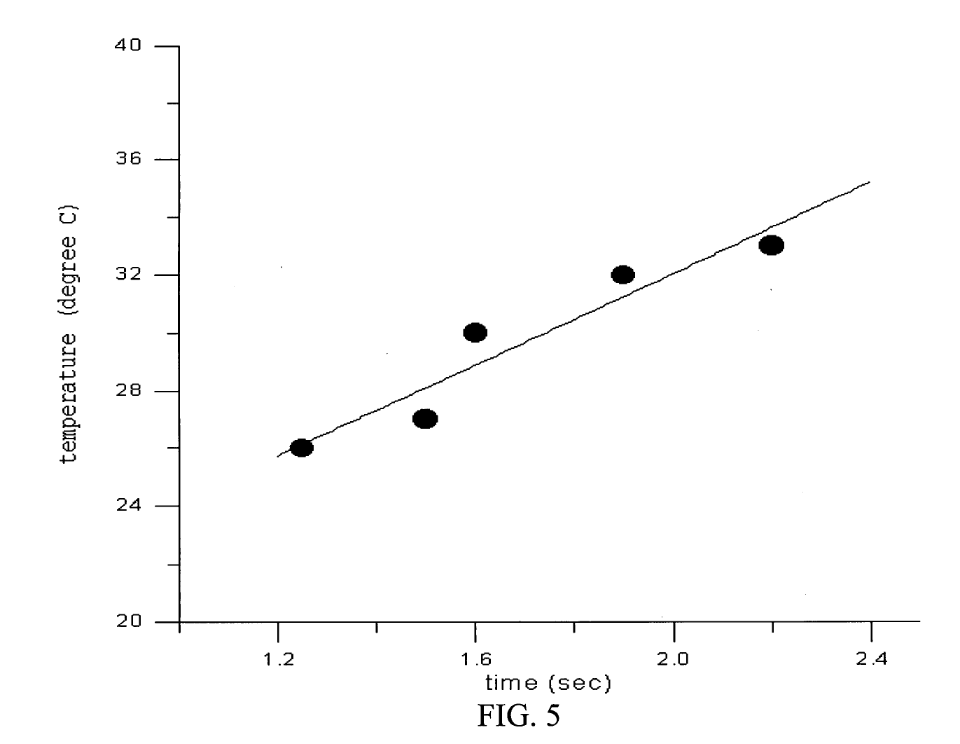

The obtained panel includes the outer layer of 1 mm-thick PAN-based carbon fiber reinforced phenolic resin composite, and the inner layer of 6 mm-thick silica fiber reinforced phenolic resin composite. The panel is subjected to 2700° C. flame jet of a rocket motor for 2 seconds at a distance of 15 cm away from the panel. The temperature on a back of the panel is not more than 33° C., as shown in FIG. 5.

Compared to the panel disclosed in U.S. Pat. No. 5,683,799, the dual-layered panel according to the invention can be obtained by molded all in one, rather than individually assembling separate layers. Furthermore, the dual-layered panel is made of carbon fiber phenolic resin that can stand up to 2500° C. in short time, significantly higher than 150° C. that polyethylene or polyproylene used to make the panel in the U.S. Pat. No. 5,683,799 stands. The dual-layered thermal insulation composite panel has a thermal diffusivity coefficient of 2.6-2.8×10⁻³ cm⁻³/sec.

### EXAMPLE 2

The outer layer of 4 layers of carbon fiber (TTII G105) reinforced phenolic resin and the inner layer of 10 layers of high-purity silica fiber fabric with reinforced phenolic resin are laminated in turn on a flat mold. The flat mold has been coated with chromium, polished and applied with a release wax (CIBA Crown Wax) already. The inner layer and the outer layer are molded by three stages. The first stage is conducted by heating for 20 minutes at molding pressure of 2000 psi and temperature of 85° C. At the second stage, the temperature is firstly increased to 150° C. at a rate of 1.3° C./min, then kept at 150° C. for 4 hours. The last stage is cooling. Thereafter, the panel is removed from the mold and cut into an appropriate size by a machine. The obtained panel has 2 mm-thick PAN-based carbon fiber reinforced phenolic resin composite and the 6 mm-thick high-purity silica fiber phenolic resin composite. The panel is subjected to 2700° C. flame jet of a rocket for 2 seconds at a distance of 15 cm away from the panel. The temperature on a back of the panel is not more than 28° C.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A process of manufacturing a dual-layered thermal insulation composite panel, the panel having an outer layer of carbon fiber reinforced phenolic resin and an inner layer of silica fiber reinforced phenolic resin, both the inner and outer layers being made into prepregs in advance and then thermal pressurized into shaping, comprising the steps of:
Providing the carbon fiber and the silica fiber in the form of 8 harness satins, wherein the carbon fiber is a PAN(polyacrylnitrile)-based carbon fiber;
providing the phenolic resin by combining 36-38% formaldehyde and 90-95% phenols with molar ratio of 1.2-1.3:1 at 100±2° C. for 50-60 minutes, using 35-37% ammonia as a catalyst, wherein isopropyl alcohol is used to dilute the phenolic resin to 60±3%;
applying the phenolic resin solution over the silica fiber and the carbon fiber at a impreganted temperature of 120±5° C. to obtain fiber prepregs; and
cutting the silica fiber and the carbon fiber prepregs into a predetermined amount, and laminating and molding said layers at 150±5° C. to obtain the dual-layered thermal insulation composite panel.

2. The process of claim 1, wherein the step of molding said layers is proceeded by using autoclave or hot press.
